(19) United States
(12) Patent Application Publication
(10) Pub. No.: US 2003/0137131 A1
(43) Pub. Date: Jul. 24, 2003

(54) Transformable personal cart

(76) Inventor: Christine B. Strange, Nashville, NC (US)

Correspondence Address: KAPLAN & GILMAN , L.L.P., 900NROUTE 9 NORTH, WOODBRIDGE, NJ, 07095, US

(21) Appl. No.: 10/348,518

(22) Filed: Jan. 20, 2003

Related U.S. Application Data
(60) Provisional application No. 60/350,411, filed on Jan. 22, 2002.

(51) Int. Cl. B62B 3/02

(52) U.S. Cl. 280/651

(57) ABSTRACT

A transformable personal cart that includes a light-weight, powder-coated metal, transformable, wheeled, frame portion; a fabric basket portion supported on the transformable, wheeled, frame portion; and a number of pouch portions assembled to the fabric basket portion.

### RELATED APPLICATION

This application is a conversion of provisional application No. 60/350,411, filed Jan. 22, 2002.

### FIELD OF THE INVENTION

The present invention relates to mechanical carrying and item moving aids and more particularly to a transformable personal cart.

### BACKGROUND OF THE INVENTION

Many times shoppers spot bargains, find an item that they have been looking to purchase a volume of for some time, or otherwise end up desiring to purchase, carry or move numerous items. It would be desirable, therefore, to have a light-weight, sturdy, transformable, rolling cart assembly that could be collapsed for easy storage and easy carrying in crowed areas, such as flea markets, malls, etc., and that when needed, could rapidly be expanded into a sturdy wheeled cart having a carrying cavity of a size sufficient for carrying a large number of items and having pouches for placing various items not desired to be placed in the main carrying cavity.

### SUMMARY OF THE INVENTION

It is thus an object of the invention to provide a transformable personal cart that includes a light-weight, powder-coated metal, transformable, wheeled, frame portion; a fabric basket portion supported on the transformable, wheeled, frame portion; and a number of pouch portions supported on the fabric basket portion; the transformable frame portion having four wheels wherein two rear wheels are provided on a separate axle passing through a bottom end of each back vertical frame member, two front wheels wherein a single front wheel is attached to a separate axle provided through each of two angled front frame member portions that are swivelably attached to the respective remainder of the angled front frame member portion such that each single front wheel rotates on an axle and swivels with respect to the front frame member portion to which it is connected, two back vertical frame members, two angled rear frame members, each terminating at a user contact end in a cushioned hand grip: and a jointed, back vertical frame member supports in a manner so that the joint is configured at an angle when the frame is collapsed and the joint is locked at a 180 degree angle when the frame is expanded for use; the fabric basket portion being formed from one piece of fabric, such as a high strength nylon, to define a basket-shaped item carrying cavity having an exterior surface and upper edges provided with a number of support loops extending therefrom that are connected to respective sections of the transformable, wheeled, frame portion to connect the fabric basket portion to the transformable, wheeled, frame portion in a manner to allow the transformable, wheeled, frame portion to be easily and rapidly configured between a closed storage and carrying configuration and an expanded rolling cart configuration; the fabric basket portion further including a rear shelf section having cup holders defined therein and hook and pile straps adapted for securing opposite side ends of the rear shelf portion to separate back angled members; the number of pouch portions including an elastic inner pouch provided on an interior wall of the fabric basket portion, a cell phone mesh pouch provided on an interior wall of the fabric basket portion, a sealable pouch having a hook and pile fastener flap closure provided on an interior wall of the fabric basket portion, and a back pouch provided on an exterior wall of the fabric basket portion positioned between the two back vertical frame member supports; a carrying handle being attached to an outwardly facing surface of one of the two back angled members to allow for easy carrying of the transformable personal cart when it is in the collapsed storage carrying configuration.

### BRIEF DESCRIPTION OF THE DRAWINGS

For a further understanding of the nature and objects of the present invention, reference should be made to the following detailed description, taken in conjunction with the accompanying drawings, in which like elements are given the same or similar reference numbers and wherein:

FIG. 1 is a side elevation view of an exemplary embodiment of the transformable personal cart of the present invention in the collapsed storage and carrying configuration.

FIG. 2 is a top plan view of the transformable personal cart of FIG. 1 in the collapsed storage and carrying configuration.

FIG. 3 is a front perspective view of the transformable personal cart of FIG. 1 in the expanded use configuration.

FIG. 4 is a rear perspective view of the transformable personal cart of FIG. 1 in the expanded use configuration.

### DETAILED DESCRIPTION OF THE INVENTION

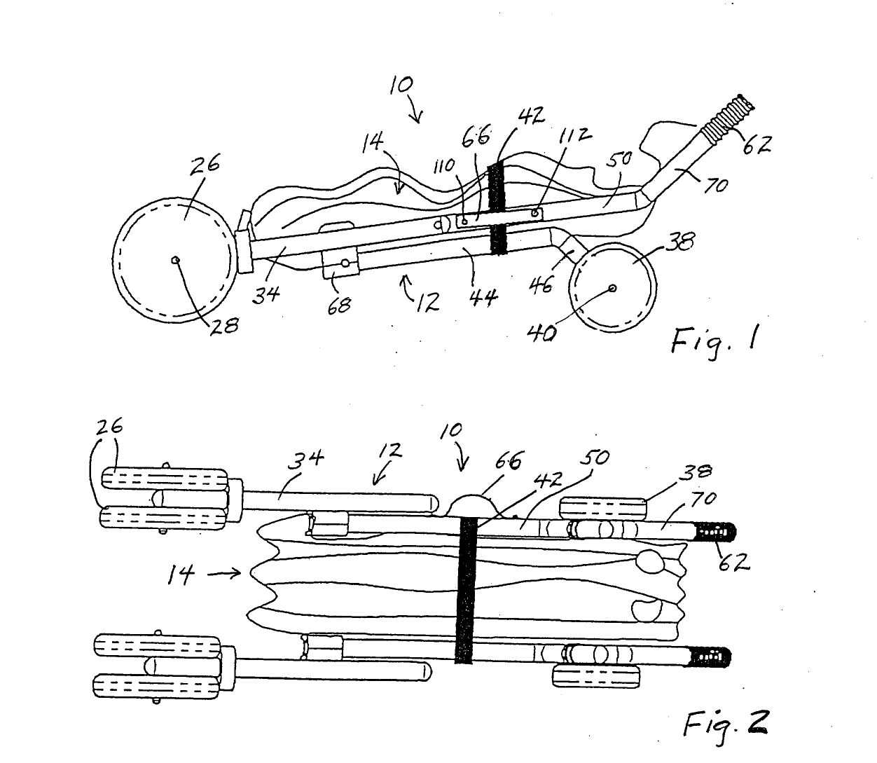

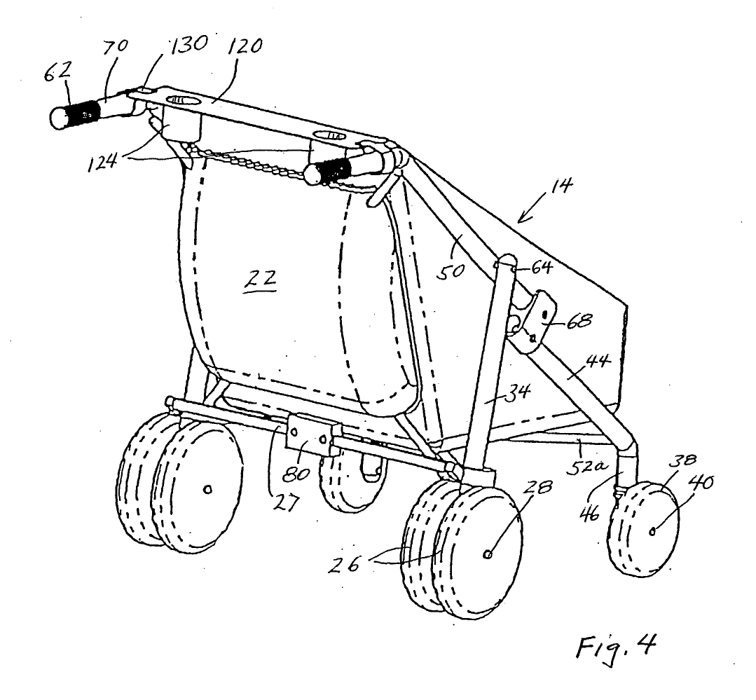

FIGS. 1-4 show various aspects of an exemplary embodiment of the transformable personal cart of the present invention generally designated 10. Transformable personal cart 10 includes a lightweight, powder-coated metal, transformable, wheeled, frame portion, generally designated 12; a fabric basket portion generally designated 14 supported on the transformable, wheeled, frame portion 12, an elastic inner pouch generally designated 16; a cell phone mesh pouch generally designated 18; a sealable pouch generally designated 20; and a back pouch generally designated 22.

Transformable frame portion 12 includes two rear substantially vertical members 34; two angled front frame members 44 that are fixedly connected to vertical front wheel mounts 46; two rear angled members 50 are pivotly connected to angled front members 44 by connector 68; two rear wheels 26 are rotatably mounted to the lower end of each vertical member 34; one front wheel 38 is rotatably mounted to each vertical wheel mount 46; a jointed, rear horizontal frame member support brace 27 having snap connector 80 is pivotally connected at opposite ends thereof to the lower end of each vertical member 34; two cushioned hand grips 62 are provided on user contact ends 70 extending horizontally at the rear of angled members 50; and a carrying handle, generally designated 66 is provided for use when the cart 10 is collapsed. Carrying handle 66 is affixed to angled member 50 by rivets 110 and 112. A bundling strap 42 is provided to band the collapsed personal cart 10 for ease of carrying and storage. Strap 42 is connected permanently to front frame member 44 according to the preferred embodiment.

Two rear wheels 26 are provided in order to support an increased load in basket portion 14 and are mounted for rotation on axle 28 passing through the bottom end of each of the two rear vertical frame members 34 in a manner not to permit swiveling. A single, wider, wheel could be used if such is preferred. A front wheel 38 is attached rotatably to an axle 40 provided through each of the two angled front frame member portions 46. Each front wheel 38 is swivelable around the bottom end of member 44 as well as being able to rotate on axle 40. Two narrower wheels could be used if preferred.

The two rear vertical members 34 are each pivotably connected to one of the upper angled frame members 50 by means of rivet 64, and each upper angled frame member 50 terminates at a horizontal user contact end 70 on which a cushioned hand grip 62 is mounted.

Jointed rear horizontal frame brace 27 is mounted pivotably to the two back vertical frame supports 34 in a manner to allow transformable personal cart 10 to collapse for storage and carrying by lifting on connector 80 and causing the two ends of frame brace 27 to approach vertical, parallel orientation. In addition, a pair of cross bars 52A and 52B are pivotally connected diagonally to respective wheel mounts 34 and 46 at opposed corners of frame 12 and are connected to one another at their crossing point by means of a pivotal rivet (not shown) or the like. When transformable personal cart 10 is collapsed to its storage position, cross bars 52A and 52B swing together in a scissors like motion to reside parallel to one another, one substantially over the other.

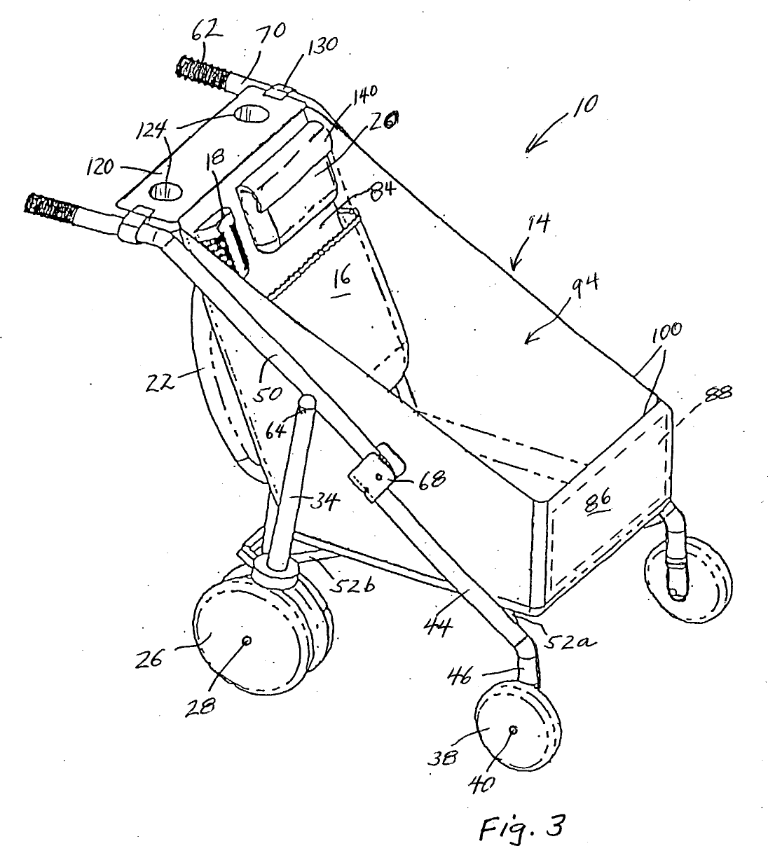

Fabric basket portion 14 is preferably formed from a sheet of high strength lightweight nylon fabric or the like and assembled by stitching or similar means as are known to have a rear inner wall surface 84 and define a substantially rectangular open basket carrying cavity, generally designated 94 having an exterior rear surface 22 and upper edges 100. A number of support loops (not shown) are provided on the outer surface of fabric basket 14 to connect same to adjacent parts of frame portion 12. The front wall 86 of fabric basket portion 14 is preferably formed as a double walled fabric sleeve in which a substantially stiff member, for example a plastic or treated cardboard sheet 88, is captured. In the preferred embodiment, the captured sheet is perforated or otherwise hinged along a vertical center line so as to allow front wall 86 to fold when cart 10 is collapsed. As will be readily understood by those skilled in the art, the combination of frame brace 27, scissor like cross frame members 52A and 52B, connecting loops, and foldable stiff front wall member 88 allow frame portion 12 to be easily and rapidly changed between a closed storage and carrying configuration (FIGS. 1 and 2) and an expanded rolling cart configuration (FIGS. 3 & 4).

According to the preferred embodiment, fabric basket portion 14 also includes a rear shelf generally designated 120. Shelf 120 is formed with two cup holders 124 or other item holder of any desired configuration and includes hook-and-loop straps 130 to connect opposite side edges of rear shelf 120 to respective user contact ends 70. Rear shelf portion 120 is preferable formed of a flexible material, for example high strength nylon fabric, and attains a substantially taut horizontal configuration when personal cart 10 is expanded to its rolling cart configuration. An elastic inner pouch 16 is provided on the inner back wall of basket 14, in addition to smaller pouches 18 and 20 which may be used, for example, for carrying a cell phone, glasses, emergency supplies, etc. Inner pouch 20 is configured with a flap cover 140 and closure means, such as snaps or hook-and-loop fasteners, to enable sealing against exposure to the elements. A preferred means of holding flap 141 closed against inner pouch 20 is with the use of a hook-and-loop fastener, as is known.

The transformable personal cart of the invention has been described herein in detail for exemplary purposes and is, of course, subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. A transformable personal cart adapted for being collapsed to a configuration for storage and carrying and expanded to a configuration for use, the cart comprising:
a) a frame having a plurality of rigid members pivotably connected to one another for allowing the frame to be transformed, the frame terminating at an upper rear portion with a pair of handles and having a plurality of wheels, some of which are swivellable;
b) a flexible basket member mounted on the frame and having a substantially stiff front wall extending upwardly from the frame;
c) a plurality of item carrying cavities assembled to one or more surfaces of the basket member; and
d) a shelf assembled between the pair of handles.

2. The transformable personal cart as described in claim 1, wherein selected ones of the plurality of wheels are configured for load bearing.

3. The transformable personal cart as described in claim 1, wherein the plurality of wheels comprise a pair of front wheels.

4. The transformable personal cart as described in claim 1, wherein selected ones of the plurality of wheels are swivelable.

5. The transformable personal cart as described in claim 2, wherein the wheels configured for load bearing are mounted to the rear of the frame.

6. The transformable personal cart as described in claim 2, wherein the load bearing wheels comprise a dual wheel set having a common supporting axle.

7. The transformable personal cart as described in claim 5, wherein the load bearing wheels comprise a dual wheel set having a common supporting axle.

8. The transformable personal cart as described in claim 1, wherein the shelf is formed with at least one cavity configured for securely holding a drink container.

9. The transformable personal cart as described in claim 8, wherein the shelf is formed with a second cavity.

10. The transformable personal cart as described in claim 9, wherein the second cavity is a drink holder.

11. The transformable personal cart as described in claim 1, wherein one of the item carrying cavities comprises a closeable pouch with a flap closure.

12. The transformable personal cart as described in claim 1, wherein one of the item carrying cavities is elasticized.

13. A frame for a transformable personal cart adapted for being collapsed to a configuration for storage and carrying and expanded to a configuration for use, the frame configured for supporting a flexible basket, comprising;
a) a pair of substantially rigid cross bars, one which extends from a rear left portion to a front right portion of the frame and another which extends from a rear right portion to a front left portion of the frame so that the bars cross one another at a point intermediate their respective lengths;
b) a frame brace formed of a pair of substantially rigid members, one which extends from the rear left portion to a rear center portion and another which extends from the rear right portion to the rear center portion to pivotally connect to the one brace so that the pair of rigid braces is transformed from a colinear orientation when the frame is in its expanded configuration to a parallel, adjacent orientation when the frame is in its collapsed configuration.

14. The frame as described in claim 13, further comprising a pivotable connector between the cross bars at their point of crossing each other.

15. The frame as described in claim 13, wherein the rigid members are pivotally connected to one another with a pivoting, locking joint.

16. The frame as described in claim 13, wherein the basket comprises a floor that rests upon the pair of cross bars when the frame is in its expanded configuration.
